(19) United States
(12) Patent Application Publication
(10) Pub. No.: US 2013/0233136 A1
(43) Pub. Date: Sep. 12, 2013

(54) Apparatus and Method for Supplying Deposition Material

(71) Applicant: SAMSUNG DISPLAY CO., LTD., Yongin-City (KR)

(72) Inventor: Sung-Jin Kim, Yongin-City (KR)

(73) Assignee: SAMSUNG DISPLAY CO., LTD., Yongin-City (KR)

(21) Appl. No.: 13/670,168

(22) Filed: Nov. 6, 2012

(30) Foreign Application Priority Data
Mar. 7, 2012 (KR) 10-2012-0023573

(51) Int. Cl. B26D 7/06; B26D 7/27

(52) U.S. Cl. 83/17; 83/162

(57) ABSTRACT

An apparatus for supplying a deposition material to a crucible that melts the deposition material includes: a wire supply roll around which the deposition material is wound as a wire; a nozzle corresponding to the deposition crucible for guiding the deposition wire to the deposition crucible; and a wire cutting unit disposed between the wire supply roll and the nozzle for guiding the deposition wire to the nozzle, and for cutting the deposition wire to a predetermined length.

### CLAIM OF PRIORITY

This application makes reference to, incorporates the same herein, and claims all benefits accruing under 35 U.S.C. §119 from an application earlier filed in the Korean Intellectual Property Office on the 7^{th} of March 2012 and there duly assigned Serial No. 10-2012-0023573.

### BACKGROUND OF THE INVENTION

1. Field of the Invention

The present information relates generally to an apparatus and method for supplying a deposition material. More particularly, the invention relates to an apparatus and method for supplying a deposition material to a crucible that melts the deposition material.

2. Description of the Related Art

As a display device which displays an image, the organic light emitting diode (OLED) display has come into the spotlight in recent years.

Unlike a liquid crystal display (LCD) device, the OLED display has a self-luminous characteristic and does not need a separate light source, thereby reducing its thickness and weight. Furthermore, the OLED display exhibits high-quality characteristics such as low power consumption, high luminance, and a high reaction speed.

In generation, the OLED display includes a first electrode, a second electrode, and an organic emission layer provided between the first and second electrodes, and the second electrode is formed as a single layer by deposition of a metal material.

A deposition material forming the second electrode is supplied to a crucible by an apparatus for supplying a deposition material, is melted therein, and is then vaporized from the crucible so that the second electrode is formed.

A conventional apparatus for supplying a deposition material supplies a deposition material as a deposition wire to the crucible using a nozzle, and when the deposition wire supplied to the crucible moves backward in the direction of the nozzle, an end portion of the deposition wire is fixed in a half-melt state to the nozzle of the apparatus so that an interference occurs when the deposition wire is supplied to the crucible again.

The above information disclosed in this Background section is only for enhancement of an understanding of the background of the described technology and therefore it may contain information that does not form the prior art that is already known in this country to a person of ordinary skill in the art.

### SUMMARY OF THE INVENTION

The present invention has been developed in an effort to provide an apparatus and method for supplying a deposition material, the apparatus having the advantage of preventing a deposition wire from being fixed to a nozzle.

One aspect of the present invention provides an apparatus for supplying a deposition material to a crucible that melts the deposition material, and the apparatus for supplying the deposition material includes: a wire supply roll around which the deposition material is wound as a wire; a nozzle corresponding to the deposition crucible, and guiding the deposition wire into the deposition crucible; and a wire cutting unit disposed between the wire supplying roll and the nozzle to guide the deposition wire into the nozzle, and cutting the deposition wire into a predetermined length.

The wire cutting unit includes: a plurality of supply rolls respectively arranged opposite each other for interposing the deposition wire therebetween, and for moving the deposition wire in a direction of the nozzle by self-rotating; and a plurality of cutting rolls respectively arranged opposite each other and between the plurality of supply rolls and the nozzle for interposing the deposition wire therebetween, and for moving the deposition wire in the direction of the nozzle by self-rotating and, at the same time, cutting the deposition wire into a predetermined length.

One of the plurality of cutting rolls may include a cutter provided in a surface thereof.

The wire cutting unit may further include an interlocking belt for connection between rotation shafts of the plurality of supply rolls and rotation shafts of the plurality of cutting rolls.

The wire cutting unit may further include a guide channel provided between the plurality of supply rolls and the plurality of cutting rolls for guiding the position wire to the plurality of cutting rolls from the plurality of supply rolls.

One of the plurality of cutting rolls may include a groove formed in a surface thereof for insertion of the deposition wire thereinto, and the cutting roll may further include a cutter provided in the groove.

Another cutting roll disposed opposite the previously described cutting roll may have a flat surface.

The wire cutting unit may further include a plurality of stretching rolls disposed opposite each other for interposing the deposition wire between the plurality of cutting rolls and the nozzle, and for moving the deposition wire in the direction of the nozzle by self-rotating.

The plurality of stretching rolls may rotate faster than the plurality of supply rolls and the plurality of cutting rolls.

The deposition wire may include metal.

The apparatus for supplying the deposition material may further include one or more guide rolls provided between the wire supply roll and the wire cutting unit for guiding the deposition wire.

According to one exemplary embodiment, an apparatus for supplying a deposition material and for preventing a deposition wire from being fixed to a nozzle can be provided.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1A shows an apparatus for supplying a deposition material according to a first exemplary embodiment of the invention, and FIG. 1B shows a method for supplying the deposition material.

FIG. 2 shows a portion “A” of FIG. 1A.

FIG. 3 shows a wire cutting unit of an apparatus for supplying a deposition material according to a second exemplary embodiment of the invention.

FIG. 4 shows a wire cutting unit of an apparatus for supplying a deposition material according to a third exemplary embodiment of the invention.

FIG. 5 shows a wire cutting unit of an apparatus for supplying a deposition material according to a fourth exemplary embodiment of the invention.

FIG. 6 shows a portion “B’ of FIG. 5.

### DETAILED DESCRIPTION OF THE INVENTION

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

In order to clarify the present invention, parts that are not connected with the description will be omitted, and the same elements or equivalents are referred to by the same reference numerals throughout the specification.

In several embodiments, the same reference numerals are used for elements having the same configuration to representatively explain the elements in a first embodiment, and only a different configuration from that of the first embodiment will be described in other embodiments.

The size and thickness of each element are arbitrarily shown in the drawings, and the present invention is not necessarily limited thereto.

In addition, unless explicitly described to the contrary, the word “comprise” and variations such as “comprises” or “comprising” will be understood to imply the inclusion of stated elements but not the exclusion of any other elements.

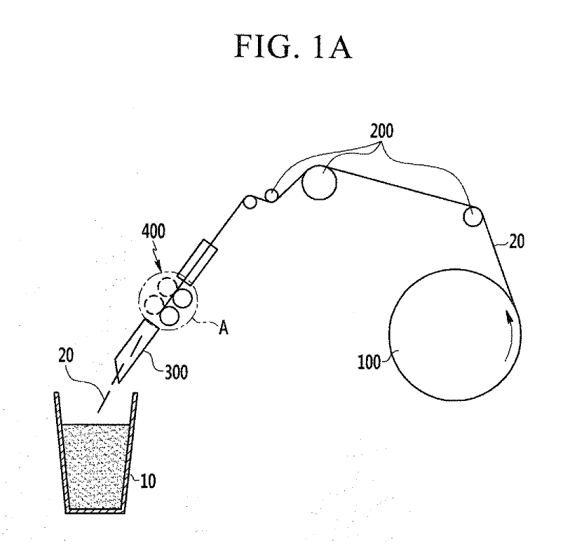

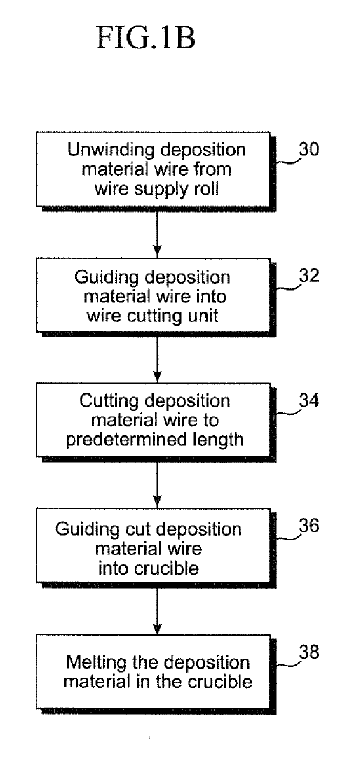

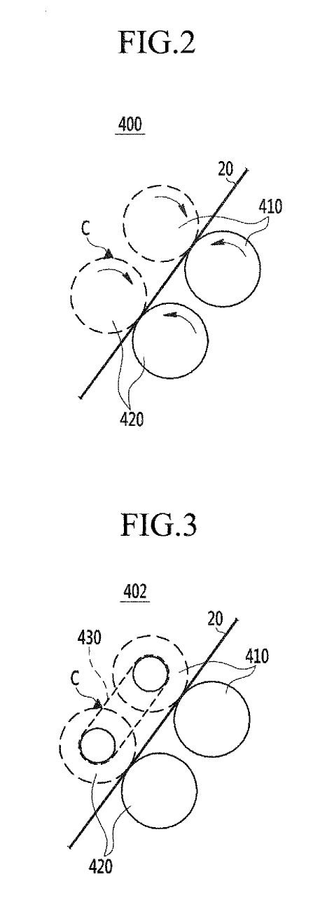

Hereinafter, an apparatus for supplying a deposition material according to a first exemplary embodiment of the invention will be described with reference to FIGS. 1A, 1B and 2. The apparatus according to the first exemplary embodiment is a device for supplying a deposition material which forms a second electrode to a crucible, but the present invention is not limited thereto. Here, the second electrode is formed as a single layer and is included in an organic light emitting diode (OLED) display.

FIG. 1A shows the apparatus for supplying the deposition material according to the first exemplary embodiment of the invention, and FIG. 1B shows a method for supplying the deposition material.

As shown in FIG. 1A, the apparatus for supplying the deposition material according to the first exemplary embodiment supplies a deposition material to a deposition crucible 10 which melts the deposition material, and the apparatus includes a wire supply roll 100, a guide roll 200, a nozzle 300, and a wire cutting unit 400.

Deposition material in the form of deposition wire 20 is wound on a wire supply roll 100. The deposition wire 20 may include a metal, particularly, aluminum (Al). The wire supply roll 100 self-rotates, and the deposition wire 20 is unwound and supplied to the guide roll 200 when the wire supply roll 100 rotates in a counterclockwise direction in the state shown in FIG. 1A (see step 30 of FIG. 1B).

The guide roll 200 is disposed between the wire supply roll 100 and the wire cutting unit 400, and transports the deposition wire 20 to the wire cutting unit 400 from the wire supply roll 100 without being loosened by self-rotating. The guide roll 200 may be provided singularly or in plural, and the number of guide rolls 200 may be changed according to an installation space and an installation format.

The nozzle 300 corresponds to the deposition crucible 10, and guides the deposition wire 20, cut to a predetermined length by the wire cutting unit 400, into the deposition crucible 10 through the guide roll 200 from the wire supply roll 100. An end portion of the nozzle 300, disposed opposite an inner side of the deposition crucible 10, may be formed as a taper.

The wire cutting unit 400 is disposed between the wire supply roll 100 and the nozzle 300 so as to cut the deposition wire 20, transferred without being sagged by the guide roll 200, to a predetermined length (see steps 32 and 34 of FIG. 1B). Since the deposition wire 20 is cut to the predetermined length by the wire cutting unit 400, the cut deposition wire 20 freely drops into the deposition crucible 10 from the nozzle 300 by gravity (see step 36 of FIG. 1B). Accordingly, the deposition wire 20 supplied to the deposition crucible 10 does not need to move backward in the direction of the nozzle 300 so that the deposition wire 20 can be prevented from being fixed in a half-melt state to the nozzle 300. Accordingly, no interference occurs when the deposition wire 20 is supplied again to the deposition crucible 10 where melting of the deposition material takes place (see step 38 of FIG. 1B).

FIG. 2 shows the portion “A” of FIG. 1.

As shown in FIG. 2, the wire cutting unit 400 includes a plurality of supply rolls 410 and a plurality of cutting rolls 420.

The plurality of supply rolls 410 are respectively disposed facing each other, interposing the deposition wire 20 therebetween, and they self-rotate so as to move the deposition wire 20 in the direction of the nozzle 300. The plurality of supply rolls 410 that face each other respectively rotate in opposite directions so as to make the deposition wire 20 move toward the plurality of cutting rolls 420. A driving unit, such as a gear, may be connected to at least one of the plurality of supply rolls 410 so as to drive rotation of the supply roll 410.

The plurality of cutting rolls 420 are disposed between the plurality of supply rolls 410 and the nozzle 300, and are respectively disposed facing each other with the deposition wire 20 interposed therebetween. The plurality of cutting rolls 420 self-rotate so as to move the deposition wire 20 in the direction of the nozzle 300 and, at the same time, cut the deposition wire 20 to the predetermined length. A driving unit, such as a gear, may be connected to at least one of the plurality of cutting rolls 420 so as to drive rotation of the cutting roll 420. One of the plurality of cutting rolls 420 includes a cutter C provided in the surface thereof, and the plurality of cutting rolls 420 disposed facing each other respectively rotate in opposite directions so that the deposition wire 20 is moved in a direction of the nozzle 300 and, at the same time, is cut to the predetermined length by the cutter C provided in the surface of the cutting roll 420. That is, the deposition wire 20 is cut to the predetermined length by the cutting roll 420 and freely drops into the deposition crucible 10 through the nozzle 300. A plurality of cutters C may be included in the cutting roll 420 according to the predetermined cutting length of the deposition wire 20.

As described, in the apparatus for supplying the deposition material according to the first exemplary embodiment, the deposition wire 20 is cut to the predetermined length by the cutter C provided in the surface of the cutting roll 420 of the wire cutting unit 400 so that the cut-out deposition wire 20 freely drops into the deposition crucible 10 from the nozzle 300 by gravity. Accordingly, there is no need to move the deposition wire 20 backward in the direction of the nozzle 300 after supplying of the deposition wire 20 to the deposition crucible 10. That is, since the deposition wire 20 cannot be fixed to the nozzle 300 when the deposition wire 20 is in a half-melted state, the apparatus for supplying the deposition material according to the first exemplary embodiment is not interfered with by the nozzle 300 when supplying the deposition wire 20 back to the deposition crucible 10.

An apparatus for supplying a deposition material according to a second exemplary embodiment will now be described with reference to FIG. 3.

Hereinafter, only characteristic parts distinguished from the first exemplary embodiment are selectively described and the other parts, the description of which is omitted, are as in the first exemplary embodiment. In the second exemplary embodiment, for better comprehension and ease of description, the same constituent elements are designated by the same reference numerals as in the first exemplary embodiment of the present invention.

FIG. 3 shows a wire cutting unit of the apparatus for supplying the deposition material according to the second exemplary embodiment of the invention.

As shown in FIG. 3, a wire cutting unit 402 of the apparatus for supplying the deposition material according to the second exemplary embodiment includes a plurality of supply rolls 410, a plurality of cutting rolls 420, and an interlocking belt 430.

The interlocking belt 430 interconnects rotation shafts of a supply roll 410 and a cutting roll 420 which are adjacent to each other among the plurality of supply rolls 410 and the plurality of cutting rolls 420. Since the rotation of the supply roll 410 and the rotation of the cutting roll 420 are interlocked by the interlocking belt 430, rotations of the supply roll 410 and the cutting roll 420 can be interlocked even though a driving unit, such as a gear, is connected to only one of the supply roll 410 and the cutting roll 420. Accordingly, rotation of one of the two rolls 410 and 420 can be prevented from being faster than rotation of the other so that a deposition wire between the supply roll 410 and the cutting roll 420 can be cut to a predetermined length without being stretched.

As described above, in the apparatus for supplying the deposition material according to the second exemplary embodiment, the wire cutting unit 402 includes the interlocking belt 430, and thus the rotation of the supply roll 410 and the rotation of the cutting roll 420 are interlocked. Accordingly, the deposition wire 20 can be cut to the predetermined length without being stretched between the supply roll 410 and the cutting roll 420. That is, since the deposition wire 20 is cut to the predetermined length without being stretched and is then supplied to a deposition crucible 10 through a nozzle 300, the supply amount of the deposition wire 20 per hour with respect to the deposition crucible 10 can be controlled by controlling the supply roll 410 or the cutting roll 420 of the wire cutting unit 402.

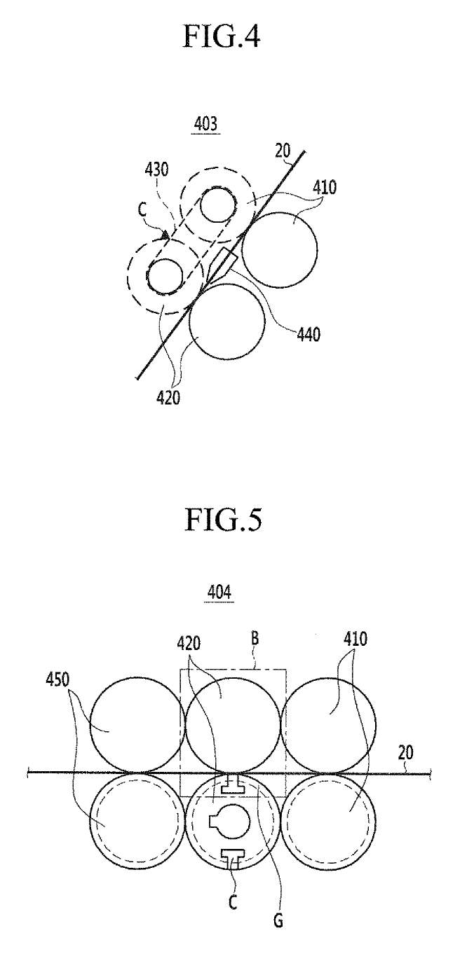

An apparatus for supplying a deposition material according to a third exemplary embodiment will now be described with reference to FIG. 4.

Hereinafter, only characteristic parts distinguished from the second exemplary embodiment are selectively described and the other parts, the description of which is omitted, are as in the second exemplary embodiment. In the third exemplary embodiment, for better comprehension and ease of description, the same constituent elements are designated by the same reference numerals as in the second exemplary embodiment.

FIG. 4 shows a wire cutting unit of the apparatus for supplying the deposition material according to a third exemplary embodiment of the invention.

As shown in FIG. 4, a wire cutting unit 403 of the apparatus for supplying the deposition material according to the third exemplary embodiment includes a plurality of supply rolls 410, a plurality of cutting rolls 420, an interlocking belt 430, and a guide channel 440.

The guide channel 440 is provided between the plurality of supply rolls 410 and the plurality of cutting rolls 420, and guides a deposition wire 20 to the plurality of cutting rolls 420 from the plurality of supply rolls 410. The guide channel 440 may be formed in the shape of a nozzle, but the shape of the guide channel 400 is not limited thereto. The guide channel 440 may have any shape that can guide the deposition wire 20 to the plurality of cutting rolls 420 from the plurality of supply rolls 410. The guide channel 440 can prevent the deposition wire 20 from being loosened or separated from a channel between the supply roll 410 and the cutting roll 420.

As described, in the apparatus for supplying the deposition material according to the third exemplary embodiment, the wire cutting unit 403 includes the interlocking belt 430 and the guide channel 440, and thus the rotation of the supply roll 410 and the rotation of the cutting roll 420 can be interlocked and, at the same time, the deposition wire 20 can be prevented from being loosened or separated from the channel. Accordingly, the deposition wire 20 can be cut to the predetermined length without being stretched, loosened, or separated from the channel. That is, since the deposition wire 20 is cut to the predetermined length and then supplied to the deposition crucible 10 without being stretched, loosened, or separated from the channel, a proper amount of deposition wire 20 can be supplied to the deposition crucible 10 per unit so that the amount of the deposition wire 20 supplied per hour with respect to the deposition crucible 10 can be controlled by controlling the supply roll 410 or the cutting roll 420 of the wire cutting unit 403, and separation of the deposition wire 20 from the wire cutting unit 403 can be prevented. That is, reliability of the apparatus for supplying the deposition material can be wholly improved.

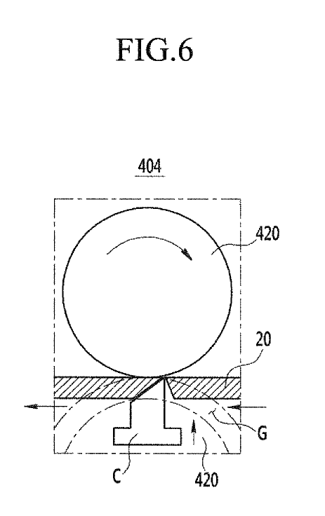

An apparatus for supplying a deposition material according to a fourth exemplary embodiment will now be described with reference to FIG. 5 and FIG. 6.

Hereinafter, only characteristic parts distinguished from the first exemplary embodiment are selectively described and the other parts, the description of which is omitted, are as in the first exemplary embodiment. In the fourth exemplary embodiment, for better comprehension and ease of description, the same constituent elements are designated by the same reference numerals as in the first exemplary embodiment.

FIG. 5 shows a wire cutting unit of an apparatus for supplying the deposition material according to the fourth exemplary embodiment of the invention.

As shown in FIG. 5, a wire cutting unit 404 of the apparatus for supplying the deposition material according to the fourth exemplary embodiment includes a plurality of supply rolls 410, a plurality of cutting rolls 420, and a plurality of stretching rolls 450.

The plurality of stretching rolls 450 are disposed between the plurality of cutting rolls 420 and the nozzle 300, and respectively face each other with a deposition wire 20 interposed therebetween. The plurality of stretching rolls 450 self-rotate so as to move the deposition wire 20 in the direction of the nozzle 300. The plurality of stretching rolls 450 rotate faster than plurality of supply rolls 410 and the plurality of cutting rolls 420. As described, since the plurality of stretching rolls 450 rotate faster than the plurality of supply rolls 410 and the plurality of cutting rolls 420, the deposition wire 20 can be stretched even though the deposition wire 20 is not cut to a predetermined length by a cutter C of the cutting roll 420 so that the deposition wire 20 can be supplied to the deposition crucible 10 through the nozzle 10 by being cut due to a stretching force.

FIG. 6 shows a portion “B” of FIG. 5.

As shown in FIG. 5 and FIG. 6, one of the plurality of cutting rolls 420 includes a groove G formed in the surface thereof for insertion of the deposition wire 20 into it, and the cutter C is provided in the groove G. In addition, the other cutting roll 420 disposed opposite the cutting roll 420 among the plurality of cutting rolls 420 has a flat surface. As described, since one of the plurality of cutting rolls 420, which are disposed opposite each other, includes the groove G and the cutter C is provided in the groove G, and since the other cutting rolls 420 disposed opposite the cutting roll 420 has a flat surface, the deposition wire 20 inserted into the groove G can be cut by the cutter C provided in the groove G even through a gap is formed between the cutting rolls 420 disposed opposite each other among the plurality of cutting rolls 420.

As described, in the apparatus for supplying the deposition material according to the fourth exemplary embodiment, one of the cutting rolls 420 includes the groove G and the cutter C provided in the groove G, and the other cutting roll 420 disposed opposite to the cutting roll 420 has a flat surface so that the deposition wire 20 inserted into the groove G can be cut by the cutter C provided in the groove G even through a gap is formed between the cutting rolls 420 disposed opposite each other. Although the deposition wire 20 is not cut by the cutter C, the deposition wire 20 is stretched by the stretching roll 450 so that the deposition wire 20 that is partially cut can be completely cut due to the stretching force applied to the deposition wire 20 and is then supplied to the deposition crucible 10 through the nozzle 300. Accordingly, the deposition wire 20 can be cut to a predetermined length and then supplied to the deposition crucible 10. That is, reliability of the apparatus for supplying the deposition material can be wholly improved.

While the invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. An apparatus for supplying a deposition material to a deposition crucible which melts the deposition material, comprising:
a wire supplying roll around which the deposition material is wound as a wire;
a nozzle corresponding to the deposition crucible for guiding the deposition wire to the deposition crucible; and
a wire cutting unit disposed between the wire supplying roll and the nozzle for guiding the deposition wire to the nozzle, and for cutting the deposition wire to a predetermined length.

2. The apparatus of claim 1, wherein the wire cutting unit comprises
a plurality of supply rolls respectively arranged opposite each other with the deposition wire interposed therebetween for moving the deposition wire in a direction of the nozzle by self-rotating; and
a plurality of cutting rolls respectively arranged opposite each other and disposed between the plurality of supply rolls and the nozzle for interposing the deposition wire therebetween, and for moving the deposition wire in the direction of the nozzle by self-rotating and, at the same time, cutting the deposition wire to the predetermined length.

3. The apparatus of claim 2, wherein one of the plurality of cutting rolls includes a cutter provided in a surface thereof.

4. The apparatus of claim 2, wherein the wire cutting unit further comprises an interlocking belt for connection between rotation shafts of the plurality of supply rolls and rotation shafts of the plurality of cutting rolls.

5. The apparatus of claim 4, wherein the wire cutting unit further comprises a guide channel provided between the plurality of supply rolls and the plurality of cutting rolls for guiding the deposition wire to the plurality of cutting rolls from the plurality of supply rolls.

6. The apparatus of claim 2, wherein one of the plurality of cutting rolls comprises a groove formed in a surface thereof for insertion of the deposition wire thereinto, and a cutter provided in the groove.

7. The apparatus of claim 6, wherein another one of the plurality of cutting rolls is disposed opposite said one of the plurality of cutting rolls and has a flat surface.

8. The apparatus of claim 2, wherein the wire cutting unit further comprises a plurality of stretching rolls disposed opposite each other for interposing the deposition wire between the plurality of cutting rolls and the nozzle, and for moving the deposition wire in a direction of the nozzle by self-rotating.

9. The apparatus of claim 8, wherein the plurality of stretching rolls rotate faster than the plurality of supply rolls and the plurality of cutting rolls.

10. The apparatus of claim 1, wherein the deposition wire comprises a metal.

11. The apparatus of claim 1, further comprising at least one guide roll provided between the wire supplying roll and the wire cutting unit for guiding the deposition wire.

12. A method for supplying a deposition material to a deposition crucible which melts the deposition material, said method comprising the steps of:
unwinding deposition material wire from a wire supply roll;
guiding the deposition material wire into a wire cutting unit;
cutting the deposition material wire to a predetermined length;
guiding the cut deposition material wire into the deposition crucible; and
melting the cut deposition material wire in the deposition crucible.

13. The method of claim 12, where the step of cutting the deposition material wire to a predetermined length is carried out by a plurality of cutting rolls respectively arranged opposite each other for interposing the deposition material wire therebetween, and for moving the deposition material wire in a direction of the deposition crucible and, at the same time, cutting the deposition material wire to the predetermined length.

14. The method of claim 13, wherein one of the plurality of cutting rolls includes a cutter provided in a surface thereof.

15. The method of claim 13, wherein rotation shafts of the plurality of cutting rolls are interconnected with rotation shafts of a plurality of supply rolls by an interlocking belt.

16. The method of claim 15, wherein the wire cutting unit further comprises a guide channel is provided between the plurality of supply rolls and the plurality of cutting rolls for guiding the deposition material wire to the plurality of cutting rolls from the plurality of supply rolls.

17. The method of claim 13, wherein one of the plurality of cutting rolls comprises a groove formed in a surface thereof for insertion of the deposition material wire thereinto, and a cutter provided in the groove.

18. The method of claim 17, wherein another one of the plurality of cutting rolls is disposed opposite said one of the plurality of cutting rolls and has a flat surface.

19. The method of claim 12, wherein the step of guiding the deposition material wire into a wire cutting unit is carried out by at least one guide roll provided between the wire supply roll and the wire cutting unit.
